(19) United States
(12) Patent Application Publication
(10) Pub. No.: US 2026/0340788 A1
(43) Pub. Date: Oct. 29, 2026

(54) IMAGE PROCESSING APPARATUS THAT REDUCES UNNECESSARY REGION FROM GEOMETRICALLY TRANSFORMED IMAGE

(71) Applicant: CANON KABUSHIKI KAISHA, Tokyo (JP)

(72) Inventor: HIROKI ITO, Kanagawa (JP)

(21) Appl. No.: 19/634,379

(22) Filed: Mar. 31, 2026

(30) Foreign Application Priority Data
Apr. 25, 2025 (JP) 2025-072939

(51) Int. Cl. G06T 5/73; G06T 3/12

(52) U.S. Cl. CPC G06T 5/73; G06T 3/12; G06T 2207/10016; G06T 2207/20104; G06T 2207/20201

(57) ABSTRACT

An image processing apparatus executes moving image acquisition processing of acquiring a shot moving image, acquisition processing of acquiring a blur correction amount for reducing blur of the moving image, image processing of performing geometric transformation on an image of each frame of the moving image, wherein in the image processing, an image in which the blur is reduced as a geometrically transformed image, based on the blur correction amount, generation processing of, based on a temporal change in the blur correction amount, generating a mask, and superimposition processing of superimposing the mask on the geometrically transformed image, wherein in the generation processing, the mask is generated such that a region not covered by the mask in the geometrically transformed image has a size designated by a user and moves by a movement amount based on the size and the temporal change in the blur correction amount.

### BACKGROUND

### Field of the Technology

The present disclosure relates to an image processing apparatus that reduces unnecessary regions from a geometrically transformed image.

### DESCRIPTION OF THE RELATED ART

In general, a VR image (VR moving image) includes two images (a left lens image and a right lens image) that can be stereoscopically viewed by a user using parallax when played on a head mounted display (HMD). The VR image includes, for example, two equirectangular projection images that are results of performing equirectangular transformation on two circular fisheye images shot through two circular fisheye lenses, respectively.

In a case in which the two circular fisheye lenses are not appropriately mounted, the parallax between the two circular fisheye images may not be suitable for stereoscopic vision. In this case, it is possible to perform transformation to generate an equirectangular projection image with parallax suitable for stereoscopic vision by adjusting parameters used for equirectangular transformation through which the circular fisheye image is transformed into an equirectangular projection image. However, as a result of the parameter adjustment, a black region can be set as a part of the equirectangular projection image by referencing an image circle outer region and a vignetting region of the circular fisheye image.

Japanese Patent Laid-Open No. 2022-184139 discloses a technique for setting a black region so that the shapes of black regions of two left and right images coincide with each other during the equirectangular transformation of a VR image.

However, according to the technique disclosed in Japanese Patent Laid-Open No. 2022-184139, unnecessary regions such as black regions cannot be reduced from a geometrically transformed image such as an equirectangular projection image.

### SUMMARY

The present disclosure provides a technique for effectively reducing unnecessary regions such as black regions from a geometrically transformed image such as an equirectangular projection image.

An image processing apparatus according to the present disclosure includes a processor, and a memory storing a program which, when executed by the processor, causes the image processing apparatus to execute moving image acquisition processing of acquiring a shot moving image, acquisition processing of acquiring a blur correction amount for reducing blur of the moving image, image processing of performing geometric transformation on an image of each frame of the moving image, wherein in the image processing, an image in which the blur is reduced as a geometrically transformed image, based on the blur correction amount, generation processing of, based on a temporal change in the blur correction amount, generating a mask, and superimposition processing of superimposing the mask on the geometrically transformed image, wherein in the generation processing, the mask is generated such that a region not covered by the mask in the geometrically transformed image has a size designated by a user and moves by a movement amount based on the size and the temporal change in the blur correction amount.

Features of the present disclosure will become apparent from the following description of embodiments with reference to the attached drawings. The following description of embodiments is described by way of example.

### BRIEF DESCRIPTION OF THE DRAWINGS

FIG. 1 is a block diagram of an editing device according to a first embodiment.

FIG. 2 is a flowchart of moving image shooting processing according to the first embodiment.

FIG. 3 is a schematic diagram of a moving image file according to the first embodiment.

FIGS. 4A-4C are schematic diagrams for describing a problem to be solved in the first embodiment.

FIG. 5 is a flowchart of the VR moving image generation processing according to the first embodiment.

FIG. 6 is a flowchart of blur correction value calculation processing according to the first embodiment.

FIG. 7 is a flowchart of mask parameter generation processing according to the first embodiment.

FIG. 8 is a graph of temporal change of a blur correction value and the like according to the first embodiment.

FIG. 9 is a flowchart of equirectangular image generation processing according to the first embodiment.

FIG. 10 is a flowchart of coordinate calculation processing according to the first embodiment.

FIG. 11 is a flowchart of pixel generation processing according to the first embodiment.

FIG. 12 is a schematic diagram of a circular fisheye image according to the first embodiment.

FIG. 13A is a schematic diagram of the circular fisheye image according to the first embodiment.

FIGS. 13B and 13C are schematic diagrams of the equirectangular image according to the first embodiment.

FIG. 14 is a block diagram of an editing device according to a second embodiment.

FIG. 15 is a flowchart of mask parameter generation processing according to the second embodiment.

FIG. 16 is a block diagram of a shooting device according to a third embodiment.

FIG. 17 is a schematic diagram of a shot image according to the third embodiment.

### DESCRIPTION OF THE EMBODIMENTS

Embodiments of the present disclosure will be described. In a case in which a moving image file of a VR image is generated, it is possible to reduce motion blur caused by camera shake (shaking of camera) by adjusting parameters used for equirectangular transformation. However, as a result of this parameter adjustment, a black region can be set as a part of the equirectangular projection image. Furthermore, a temporal change of the parameters causes the black region to move, resulting in flickering in the periphery of the equirectangular projection image. By superimposing, on the equirectangular projection image, a mask that exposes a central portion of the image, an unnecessary region can be eliminated (covered) by the mask, but an effective region where the video is present is reduced. In the following embodiment, an image having a small unnecessary region such as a black region and a wide effective region is obtained as a geometrically transformed image such as an equirectangular projection image.

### First Embodiment

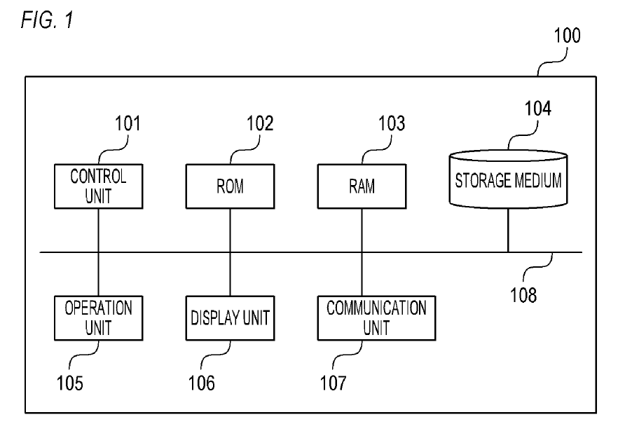

Hereinafter, a first embodiment of the present disclosure will be described. FIG. 1 is a block diagram illustrating a configuration of an editing device 100 which is an example of an image processing apparatus according to the first embodiment. The editing device 100 is, for example, an electronic device such as a computer, a smartphone, or a shooting device (such as a digital camera). The editing device 100 includes a control unit 101, a ROM 102, a RAM 103, a storage medium 104, an operation unit 105, a display unit 106, a communication unit 107, and a system bus 108.

The control unit 101 controls the entire editing device 100. The control unit 101 is, for example, a central processing unit (CPU). The control unit 101 can also perform image generation, setting processing, and calculation processing.

The ROM 102 is a read only memory (ROM) that stores information (programs and parameters) that does not need to be changed.

The RAM 103 is a random access memory (RAM) that temporarily stores information (programs and data) supplied from an external device or the like.

The storage medium 104 is fixedly installed in the editing device 100. The storage medium 104 is a hard disk or a flash memory. The storage medium 104 may be detachable from the editing device 100. The storage medium 104 may be an optical disk such as a floppy disk (FD) or a compact disk (CD), or may be a magnetic card, an optical card, an IC card, a memory card, or the like.

The operation unit 105 receives a user's operation (an instruction from the user). The operation unit 105 includes an operation member (such as a button or a touch panel) that can be operated by a user.

The display unit 106 displays the data stored in the editing device 100 and the data supplied to the editing device 100.

The communication unit 107 communicates with an external device such as a camera (shooting device; digital camera).

The system bus 108 communicably connects a plurality of components (units) to each other.

A moving image file including image data, metadata, and the like is stored (recorded) in the storage medium 104. The moving image file can be read from the storage medium 104. The communication unit 107 can also receive a moving image file from an external device such as a camera. A method of acquiring the moving image file (moving image acquisition) is not particularly limited.

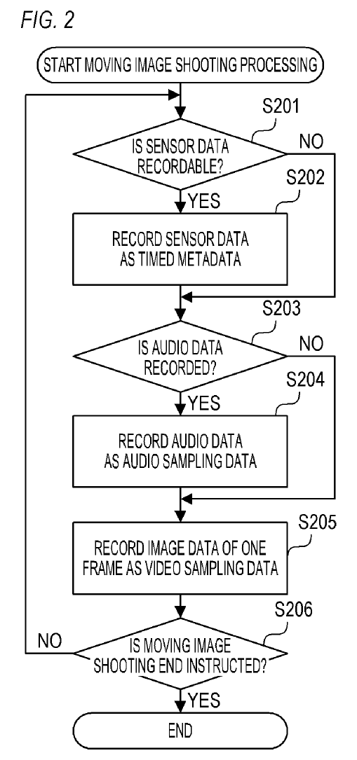

FIG. 2 is a flowchart illustrating moving image shooting processing performed by a camera (shooting device) communicable with the editing device 100.

In step S201, a camera determines whether sensor data can be stored (recorded) in a moving image file. The sensor data is, for example, inertial data indicating acceleration measured by a gyro sensor. The camera can record the movement (posture change) of the camera during shooting of a moving image by periodically storing the inertial data of the gyro sensor in the moving image file. In a case in which the camera determines that the sensor data can be stored in the moving image file, the processing proceeds to step S202. In a case in which the camera determines that the sensor data cannot be stored in the moving image file, the processing proceeds to step S203.

In step S202, the camera stores the sensor data in the moving image file as timed metadata (metadata which is time-series information).

In step S203, the camera determines whether to store audio data (sound data) in the moving image file. The camera does not store the audio data in the moving image file depending on a shooting mode. In a case in which the camera determines to store the audio data in the moving image file, the processing proceeds to step S204. In a case in which the camera determines not to store the audio data in the moving image file, the processing proceeds to step S205.

In step S204, the camera stores the audio data (sound data) as audio sampling data in the moving image file.

In step S205, the camera stores image data of one frame in the moving image file as video sampling data.

In step S206, the camera determines whether the end of the moving image shooting has been instructed. In a case in which the camera determines that an instruction to end moving image shooting has been given, the moving image shooting processing ends. In a case in which the camera determines that the instruction to end the moving image shooting has not been given, the processing proceeds to step S201.

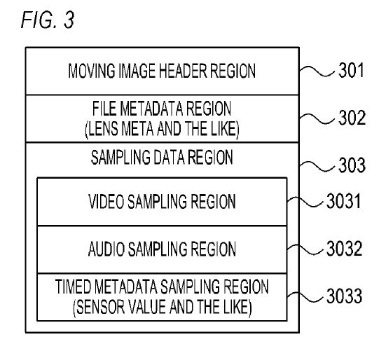

FIG. 3 is a schematic diagram illustrating a structure of a moving image file acquired by the camera through the moving image shooting processing in FIG. 2. The moving image file includes a moving image header region 301, a file metadata region 302, and a sampling data region 303.

The moving image header region 301 stores information regarding the entire moving image (hereinafter, referred to as “moving-image related information”). For example, the moving-image related information includes at least one of information such as an image size (width and height) of a moving image, a frame rate of the moving image, a sample frequency of audio (sound), a sample size of audio, and the number of channels of audio. The moving-image related information may include information such as the time position (playback position; playback time) and size of a sample (an image of one frame in the case of video) for each medium (video, audio, timed metadata, and the like).

The file metadata region 302 stores metadata regarding a file itself, metadata regarding the entire moving image, or the like. For example, in the file metadata region 302, information regarding a lens at the time of shooting, a design value (such as a center position or a radius of an image circle), a measurement value measured by calibration, or the like is stored as metadata.

The sampling data region 303 stores sampling data of each medium. The sampling data region 303 includes a video sampling region 3031, an audio sampling region 3032, and a timed metadata sampling region 3033.

The video sampling region 3031 stores sampling data of a video medium. The sampling data of the video medium is the image data stored in step S205 of FIG. 2. For example, in a case in which two fisheye lenses are attached to the camera, two circular fisheye images respectively corresponding to the two fisheye lenses (a plurality of images respectively corresponding to a plurality of optical systems) are stored in the video sampling region 3031 as a one-frame video sample. A single image having two circular fisheye image regions may be stored as one-frame video sample.

The audio sampling region 3032 stores sampling data of an audio medium. The sampling data of the audio medium is the audio data stored in step S204 of FIG. 2. In a case in which the audio data is not recorded, the audio sampling region 3032 may not be present.

The timed metadata sampling region 3033 stores sampling data of a timed metadata medium. The sampling data of the timed metadata medium is, for example, the sensor data stored in step S202 of FIG. 2. In a case in which the timed metadata is not recorded, the timed metadata sampling region 3033 may not be present.

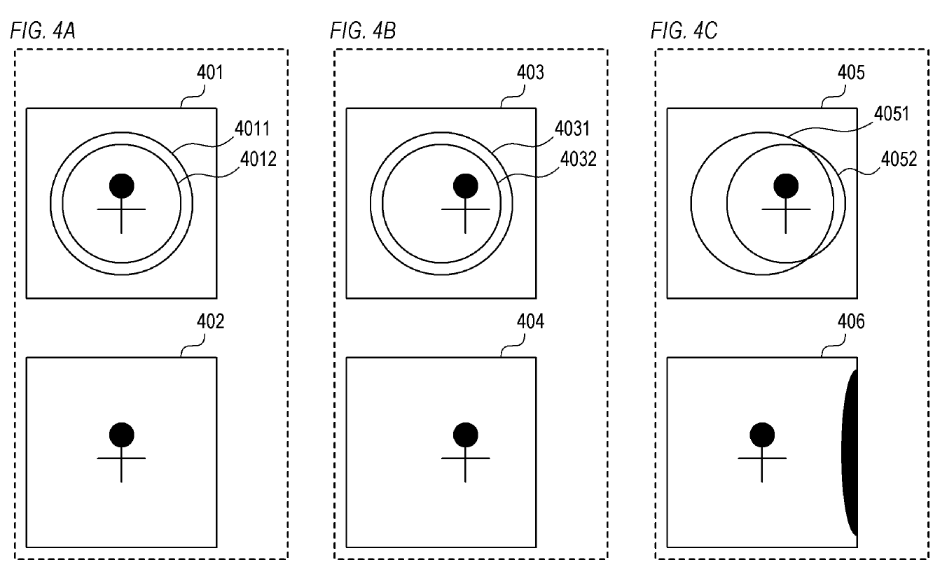

The editing device 100 generates a VR moving image (VR180 moving image) by performing equirectangular transformation on the circular fisheye image recorded by the camera. FIGS. 4A-4C are schematic diagrams illustrating a circular fisheye image recorded by the camera and an equirectangular projection image (hereinafter, referred to as an “equirectangular image”) obtained by the editing device 100. The equirectangular image is an image obtained by performing equirectangular transformation on the circular fisheye image. Note that, in order to simplify the description, one circular fisheye image recorded by a camera equipped with one fisheye lens and one equirectangular image generated from the circular fisheye image will be described. However, the same description as the following description holds for two circular fisheye images recorded by a camera equipped with two fisheye lenses and two equirectangular images generated from the two circular fisheye images.

In FIG. 4A, a circular fisheye image 401 is one circular fisheye image recorded by a camera equipped with a fisheye lens. An image circle 4011 (a region inside the image circle 4011) is a region (shooting region) shot by the camera via the fisheye lens, and is an effective region where a video is present. An object is photographed inside the image circle 4011. A region outside the image circle 4011 is an invalid region without video. The color of the invalid region is not particularly limited, and is, for example, black or a color close to black. The invalid region is a region independent of the object. Information about the image circle 4011 (information such as the center position and the radius of the image circle 4011) in the circular fisheye image 401 is stored in the file metadata region 302 as file metadata. Normally, since the position of the lens (the relative position of the lens with respect to an imaging element) does not change during moving image shooting, the position of the image circle 4011 is constant.

A region 4012 is a region to be subjected to equirectangular transformation. The inside of the region 4012 is transformed into an equirectangular image. The information about the region 4012 is also stored in the file metadata region 302 as file metadata. The center position of the region 4012 is the same as the center position of the image circle 4011 by default, but can be changed.

An equirectangular image 402 is an equirectangular image obtained by performing equirectangular transformation on the region 4012. The object is arranged at the center position of the equirectangular image 402.

In FIG. 4B, a circular fisheye image 403 is one circular fisheye image recorded by the camera, similarly to the circular fisheye image 401. Similarly to the image circle 4011, an image circle 4031 is a shooting region and an effective region. A region outside the image circle 4031 is an invalid region, similarly to the region outside the image circle 4011. Similarly to the region 4012, a region 4032 is a region to be subjected to equirectangular transformation.

In the circular fisheye image 403, the camera is slightly directed to the left from the posture of the camera at the time of recording the circular fisheye image 401, so that the object is arranged at a position slightly shifted to the right side from the center position of the image circle 4031.

An equirectangular image 404 is an equirectangular image obtained by performing equirectangular transformation on the region 4032. The relative position of the region 4032 with respect to the image circle 4031 in the circular fisheye image 403 is the same as the relative position of the region 4012 with respect to the image circle 4011 in the circular fisheye image 401. Therefore, the object is arranged at a position slightly shifted to the right side from the center position of the equirectangular image 404.

In FIG. 4C, a circular fisheye image 405 is one circular fisheye image recorded by the camera, similarly to the circular fisheye image 401 and the circular fisheye image 403. An image circle 4051 is a shooting region and an effective region, similarly to the image circle 4011 and the image circle 4031. A region outside the image circle 4051 is an invalid region, similarly to the region outside the image circle 4011 and the region outside the image circle 4031. Similarly to the regions 4012 and 4032, a region 4052 is a region to be subjected to equirectangular transformation.

In the circular fisheye image 405, similarly to the circular fisheye image 403, the object is arranged at a position slightly shifted to the right side from the center position of the image circle 4051. Furthermore, a region 4052 is arranged at a position slightly shifted to the right side from the position of the region 4012 and the position of the region 4032.

An equirectangular image 406 is an equirectangular image obtained by performing equirectangular transformation on the region 4052. By arranging the region 4052 at a position slightly shifted to the right side from the position of the region 4012 and the position of the region 4032, the object is arranged at the center position of the equirectangular image 406. As described above, in the present embodiment, when the equirectangular image is generated from the circular fisheye image, the region to be subjected to the equirectangular transformation in the circular fisheye image is changed. As a result, blurring of the moving image caused by camera shake (shaking of camera) can be reduced.

However, since a part (right end portion) of the region 4052 protrudes from the image circle 4051, an unnecessary region corresponding to the invalid region of the circular fisheye image 405 is set as a part (right end portion) of the equirectangular image 406. When camera shake continues during moving image shooting, this unnecessary region moves, and flickering occurs in the peripheral portion of the equirectangular image. Furthermore, in a case in which the user views the VR moving image obtained by the equirectangular transformation using a head mounted display (HMD), movement of an unnecessary region may cause not only a sense of discomfort of the user but also VR sickness.

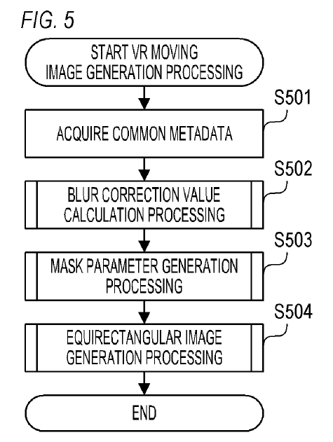

FIG. 5 is a flowchart illustrating VR moving image generation processing of generating a VR moving image. The VR moving image generation processing of FIG. 5 is realized by the control unit 101 loading a program recorded in the ROM 102 in the RAM 103 and executing the program. For example, when the user instructs the editing device 100 to execute a function of generating a VR moving image by performing equirectangular transformation for transforming a circular fisheye image into an equirectangular image, the operation of FIG. 5 starts.

In step S501, the control unit 101 reads common metadata (metadata common to all frames) stored in the file metadata region 302 of the moving image file. For example, the common metadata includes information such as the center position of an image circle, the radius of the image circle, and the radius of a region to be subjected to the equirectangular transformation. The control unit 101 also reads a parameter value (a manual correction parameter value) set by the user using the operation unit 105 as metadata. These pieces of metadata are used to generate an equirectangular image from the circular fisheye image in a later step.

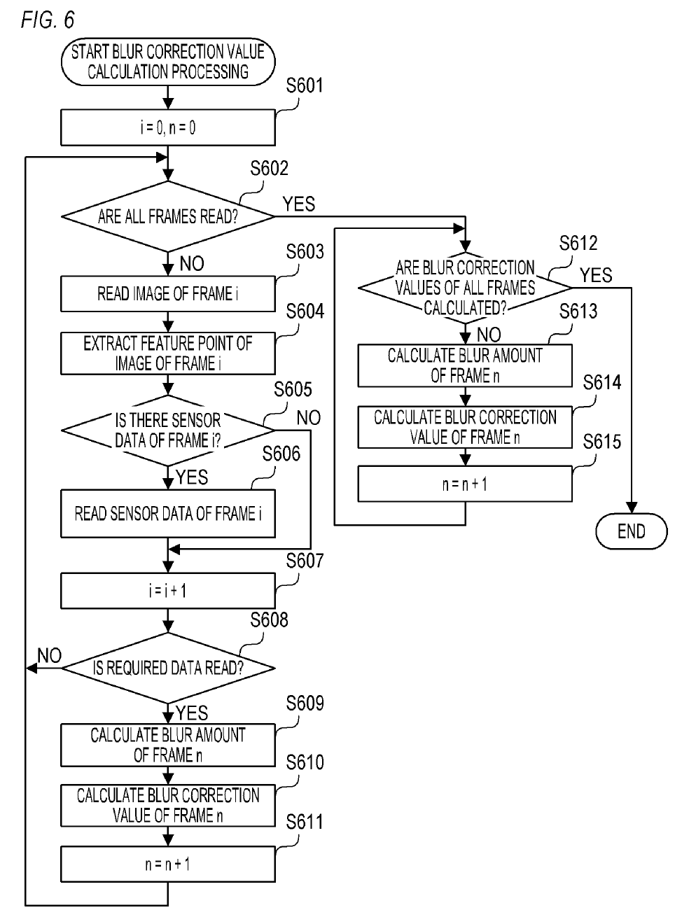

In step S502, the control unit 101 performs processing of calculating a blur correction value (a blur correction amount) of each frame (blur correction value calculation processing). Details of the blur correction value calculation processing will be described later with reference to FIG. 6. The blur correction value (blur correction amount) is a correction value (correction amount) that reduces the blur of the moving image caused by the camera shake (shaking of camera).

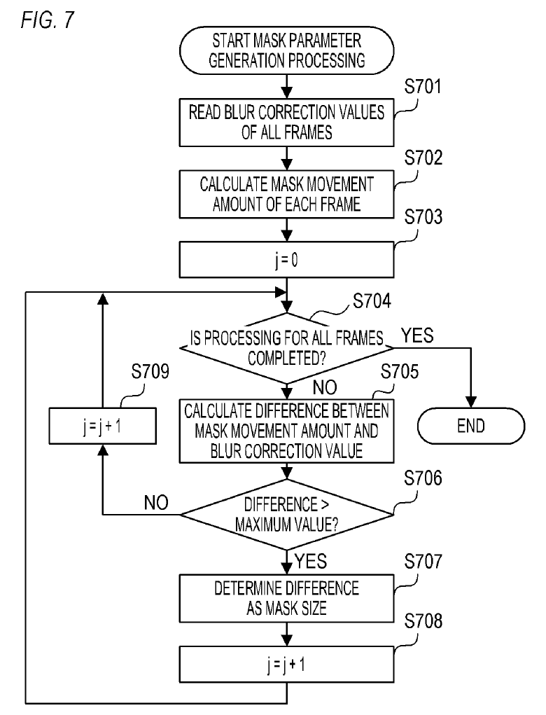

In step S503, the control unit 101 performs processing of generating a mask parameter of each frame (mask parameter generation processing). Details of the mask parameter generation processing will be described later with reference to FIG. 7. A mask parameter is a parameter related to a mask to be superimposed on the equirectangular image. The mask parameter generation processing may be interpreted as processing of generating a mask.

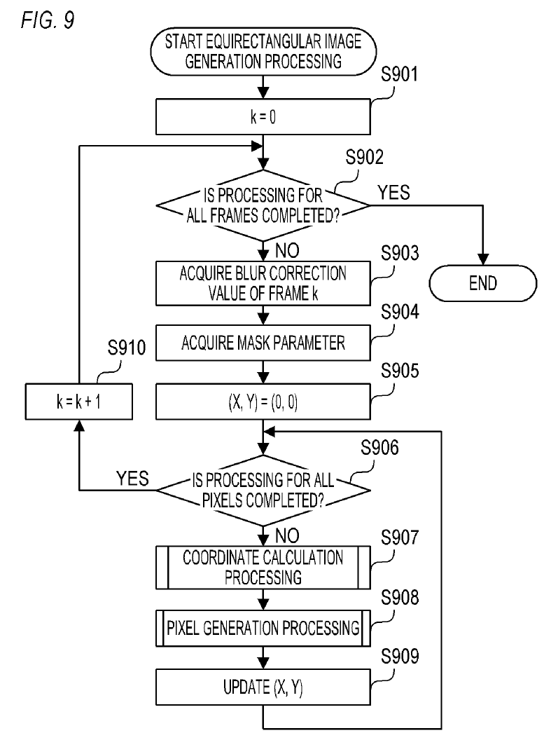

In step S504, the control unit 101 performs processing of generating an equirectangular image of each frame (equirectangular image generation processing). Details of the equirectangular image generation processing will be described later with reference to FIG. 9.

FIG. 6 is a flowchart illustrating blur correction value calculation processing performed in step S502 of FIG. 5.

In step S601, the control unit 101 sets each of a variable i representing the frame number of the image data to be read and a variable n representing the frame number of the image data for which the blur correction value is calculated to 0.

In step S602, the control unit 101 determines, based on the variable i, whether the image data of all the frames (the image data of the circular fisheye image) stored in the moving image file has been read. In a case in which the control unit 101 determines that the image data of all the frames has been read, the processing proceeds to step S612. In a case in which the control unit 101 determines that the image data of at least one frame has not been read, the processing proceeds to step S603.

In step S603, the control unit 101 reads image data of a circular fisheye image of a frame having a frame number i (= frame i) from the video sampling region 3031 of the moving image file. Here, in a case in which the image data stored in the video sampling region 3031 is compressed, the control unit 101 decodes the image data. The format of the decoded image data is not particularly limited, and is, for example, image data in an RGB format.

In step S604, the control unit 101 analyzes the read image data (executes image processing on the image data) and extracts feature points in the circular fisheye image.

In step S605, the control unit 101 determines whether the sensor data of the frame i is stored in the timed metadata sampling region 3033 of the moving image file. In a case in which the control unit 101 determines that the sensor data of the frame i is stored, the processing proceeds to step S606. In a case in which the control unit 101 determines that the sensor data of the frame i is not stored, the processing proceeds to step S607.

In step S606, the control unit 101 reads the sensor data of the frame i (sensor data regarding the movement of the camera during shooting of the circular fisheye image of the frame i) from the timed metadata sampling region 3033.

In step S607, the control unit 101 updates the variable i by adding 1 to the variable i indicating the read frame number.

In step S608, the control unit 101 determines whether image data of a frame necessary for calculating the blur amount of a frame having a frame number n (= frame n) has been read. For example, the blur amount is the magnitude of the camera shake, the camera movement amount caused by the camera shake, or the movement amount of the object in the image caused by the camera shake in a specific period centered on the time of one frame. Therefore, for example, in order to calculate the blur amount of one frame, image data of frames for one second before and after the one frame is used. The required frame may vary depending on the variable n (frame n). For example, in a case in which there is no frame before the frame n, the required frame may include only frames after the frame n. In a case in which there is no frame after the frame n, the required frame may include only frames before the frame n. The time of the frame n in the period of the required frame may not be the center of the period. In a case in which the control unit 101 determines that image data of the required frame has been read, the processing proceeds to step S609. In a case in which the control unit 101 determines that the image data of the required frame has not been read, the processing proceeds to step S602.

In step S609, the control unit 101 calculates the blur amount of the frame n. For example, the control unit 101 calculates the blur amount of the frame n based on the feature points and the sensor data of the frame n and the frames before and after the frame n. Note that the control unit 101 may calculate the blur amount based on only the feature points or may calculate the blur amount based on only the sensor data.

The movement of the camera due to an unintended camera shake of the user is different from the movement of the camera as camera work. For example, in a case in which camera shake occurs, the camera reciprocates leftwards and rightwards, upwards and downwards, or the like in a short cycle. Therefore, the control unit 101 can calculate the blur amount based on a movement pattern of feature points during the period of the plurality of frames or a change pattern of values obtained from the gyro sensor provided in the camera during the period.

In step S610, the control unit 101 calculates, based on the blur amount of the frame n calculated in step S609, a blur correction value for reducing (eliminating) the blur of the moving image corresponding to the blur amount as a blur correction value of the frame n. For the calculation of the blur correction value, various methods used for calculating the correction value of the camera shake correction and the like can be used. The control unit 101 calculates an inverse vector of the blur amount vector as a vector of the blur correction value.

In step S611, the control unit 101 updates the variable n by adding 1 to the variable n.

As described above, in order to calculate the blur correction value of one frame, information about the preceding and following frames of the frame is also necessary. Therefore, at the time when all the frames have been read, a plurality of frames for which blur correction values have not been calculated remain. Therefore, the following processing of steps S612 to S615 is performed.

In step S612, the control unit 101 determines, based on the variable n, whether the blur correction values of all the frames have been calculated. In a case in which the control unit 101 determines that the blur correction values of all the frames have been calculated, the blur correction value calculation processing ends. In a case in which the control unit 101 determines that the blur correction value of at least one frame has not been calculated, the processing proceeds to step S613.

In step S613, the control unit 101 calculates the blur amount of the frame n, in the same manner as in step S609.

In step S614, similarly to step S610, the control unit 101 calculates, based on the blur amount of the frame n calculated in step S613, a blur correction value for reducing (eliminating) the blur of the moving image corresponding to the blur amount as the blur correction value of the frame n.

In step S615, the control unit 101 updates the variable n by adding 1 to the variable n.

Note that an example in which the editing device 100 (the control unit 101) calculates, based on the moving image and the sensor data, the blur correction value has been described, but the method of acquiring the blur correction value is not limited thereto. For example, the camera may calculate a blur correction value during moving image shooting or the like, and may store the calculated blur correction value in the moving image file. Then, the editing device 100 (the control unit 101) may read the blur correction value from the moving image file.

FIG. 7 is a flowchart illustrating the mask parameter generation processing performed in step S503 of FIG. 5. In the mask parameter generation processing, a mask (mask parameter) is generated based on a temporal change of the blur correction value. In the first embodiment, the mask parameters include a mask movement amount and a mask size.

In step S701, the control unit 101 reads the blur correction values of all the frames calculated in step S502. In step S502, it is assumed that a plurality of blur correction values corresponding to a plurality of directions are calculated for the respective frames. For example, a pan axis, a tilt axis, and a roll axis are determined based on a predetermined posture of the camera. Then, in step S502, three blur correction values of a pan correction value, a tilt correction value, and a roll correction value corresponding to a direction of rotation about the pan axis, a direction of rotation about the tilt axis, and a direction of rotation about the roll axis, respectively, are calculated. The plurality of correction values respectively corresponding to the plurality of directions are similarly used. In the following, an example of using one type of correction value will be described in order to simplify the description.

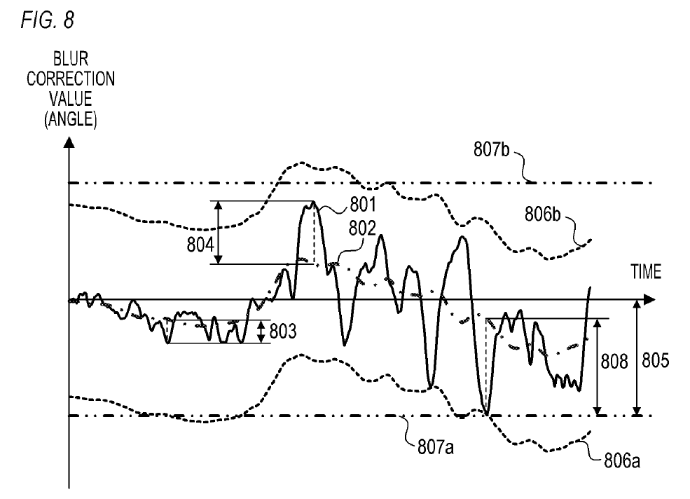

In step S702, the control unit 101 calculates a mask movement amount of each frame using the blur correction values of all the frames read in step S701. The mask movement amount is a movement amount of a region (opening region) not covered by the mask in the equirectangular image, and is, for example, a movement amount of the center position of the opening region from the center position of the equirectangular image. For example, the control unit 101 calculates the moving average of the blur correction value as the mask movement amount. In FIG. 8, a horizontal axis represents time, and a vertical axis represents a blur correction value. A solid line 801 indicates the temporal change of the blur correction value calculated in step S502, and an alternate long and short dash line 802 indicates the temporal change of the moving average of the blur correction value (mask movement amount). If the moving average period, which is a period for averaging the blur correction values, is long, the temporal change of the moving average (mask movement amount) becomes gentle, and if the moving average period is short, the temporal change of the moving average (mask movement amount) becomes steep. The moving average period is not particularly limited, and is, for example, a period of 50 frames. It is preferable to set the moving average period so that a sense of discomfort does not occur in the movement of the opening region.

Note that the mask movement amount may be a simple moving average calculated without performing weighting, or may be a weighted moving average calculated by performing weighting. Another value corresponding to the moving average may be acquired as the mask movement amount. A value indicating a temporal change in which a temporal change of the blur correction value is made gentle may be acquired as the mask movement amount using a frequency filter such as a low-pass filter. A method of determining the mask movement amount is not particularly limited as long as the opening region moves more slowly than the movement of a region to be subjected to equirectangular transformation.

In step S703, the control unit 101 sets a variable j representing the frame number for which a difference (an absolute value) between the blur correction value and the mask movement amount (moving average) is calculated to 0.

In step S704, the control unit 101 determines, based on the variable j, whether the difference between the mask movement amount (moving average) calculated in step S702 and the blur correction value calculated in step S502 has been calculated for all the frames. In a case in which the control unit 101 determines that the difference has been calculated for all the frames, the mask parameter generation processing ends. In a case in which the control unit 101 determines that the difference has not been calculated for at least one frame, the processing proceeds to step S705.

In step S705, the control unit 101 calculates a difference (deviation amount) between the mask movement amount (moving average) and the blur correction value of a frame having a frame number j (= frame j).

In step S706, the control unit 101 determines whether the difference calculated in step S705 is greater than the maximum value of the differences calculated up to the previous time. In a case in which the control unit 101 determines that the difference is greater than the maximum value, the processing proceeds to step S707. Also in a case in which the control unit 101 calculates the difference for the first time, the processing proceeds to step S707. In a case in which the control unit 101 determines that the difference is equal to or less than the maximum value, the processing proceeds to step S709.

In step S707, the control unit 101 determines the difference (maximum value) calculated in step S705 as the mask size. The mask size is the size of the opening region described above.

In step S708, the control unit 101 updates the variable j by adding 1 to the variable j.

In step S709 as well, the control unit 101 updates the variable j by adding 1 to the variable j.

By performing the processing in steps S704 to S709 for all the frames, the maximum value of the differences (differences between the mask movement amount (moving average) and the blur correction value) calculated for all the frames is determined as the mask size. Note that another value or the like corresponding to the maximum value of the difference between the mask movement amount (moving average) and the blur correction value may be determined as the mask size.

In the example of FIG. 8, after a difference 803 is determined as the mask size, the mask size is updated to a difference 804, and the mask size is updated to a difference 808. Finally, the difference 808 is determined as the mask size.

In the first embodiment, since the mask movement amount is determined for each frame, it may change, but since only one mask size is determined for the moving image, it does not change. Since the mask size does not change, the field of view does not narrow or widen in the middle of the moving image. However, the method of determining the mask movement amount and the mask size is not limited to those described above, and the mask movement amount and the mask size may be determined such that the mask size changes according to a change in the mask movement amount (movement of the opening region).

FIG. 9 is a flowchart illustrating the equirectangular image generation processing performed in step S504 of FIG. 5.

In the equirectangular image generation processing, an image in which blurring of a moving image is reduced (eliminated) is acquired as the equirectangular image on the basis of the blur correction value. In the VR moving image using the equirectangular image in which the blurring of the moving image is reduced (eliminated), for example, the relative position of a stationary object with respect to the equirectangular image does not (substantially) change. Therefore, when viewing the VR moving image using the HMD, the user can view a stationary object in a certain direction.

Furthermore, in the equirectangular image generation processing, a mask is superimposed on the equirectangular image based on the mask parameters generated in step S503. By superimposing the mask on a region including an unnecessary region so as to hide (movement of) the unnecessary region corresponding to an invalid region (a region outside an image circle) of the circular fisheye image, it is possible to suppress flickering in the peripheral portion of the equirectangular image. As a result, it is possible to suppress a sense of discomfort of the user, VR sickness, and the like in a case in which the user views the VR moving image using the HMD.

In the first embodiment, since the opening region of the mask moves, it is possible to set a wider opening region than a case in which the opening region is fixed. Therefore, it is possible to obtain an image having a small unnecessary region and a wide effective region as the equirectangular image after the mask is superimposed.

In step S901, the control unit 101 sets a variable k representing a frame number for which an equirectangular image is generated to 0.

In step S902, the control unit 101 determines, based on the variable k, whether the equirectangular images have been generated for all the frames. In a case in which the control unit 101 determines that the equirectangular images have been generated for all the frames, the equirectangular image generation processing ends. In a case in which the control unit 101 determines that the equirectangular image has not been generated for at least one frame, the processing proceeds to step S903.

In step S903, the control unit 101 acquires a blur correction value of a frame having a frame number k (= frame k) calculated in step S502.

In step S904, the control unit 101 acquires mask parameters (the mask movement amount and mask size of the frame k) calculated in step S503. The processing in steps S902 to S910 is performed for each frame, but information about the mask size may be acquired once.

In step S905, the control unit 101 sets processing target coordinates (coordinates at which pixels of the equirectangular image of the frame k are generated) (X, Y) to initial coordinates (0,0).

In step S906, the control unit 101 determines whether all the pixels of the frame k have been generated. In a case in which the control unit 101 determines that all the pixels have been generated, the processing proceeds to step S910, and in a case in which the control unit 101 determines that at least one pixel has not been generated, the processing proceeds to step S907.

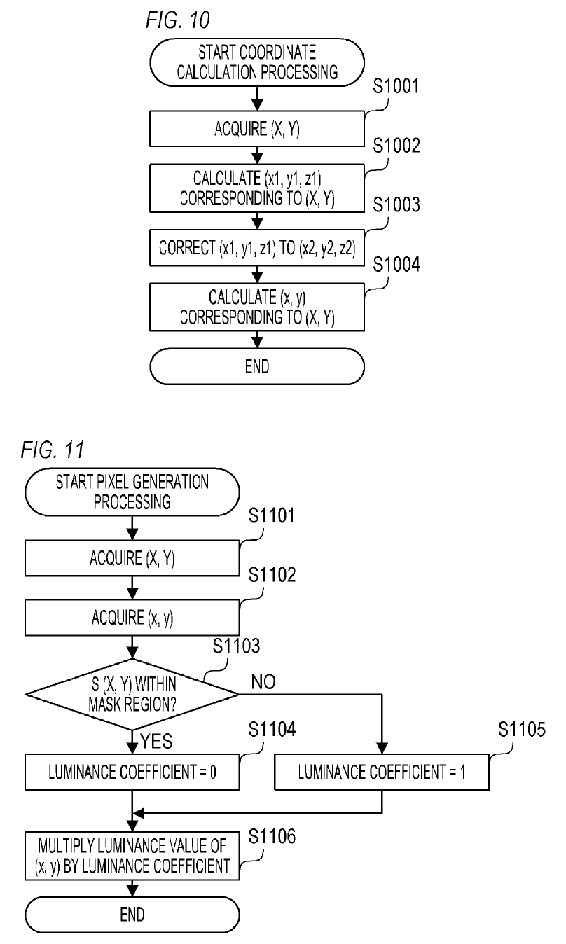

In step S907, the control unit 101 performs processing (coordinate calculation processing) of calculating coordinates of the circular fisheye image corresponding to the coordinates of the equirectangular image. Details of the coordinate calculation processing will be described later with reference to FIG. 10. In general, in a circular fisheye image, when a focal length is defined as f and an angle of view is defined as θ, an imaging position is represented by f×θ. This projection method is a lens projection method such as a so-called equidistant projection lens. In the equirectangular image, an azimuth angle λ and an elevation angle ψ in the three-dimensional space are plotted in the X direction and the Y direction, respectively. Based on these, the xy coordinates in the circular fisheye image can be calculated from the XY coordinates in the equirectangular image. In addition, by using the blur correction value acquired in step S903, it is possible to calculate the xy coordinates of the circular fisheye image corresponding to the XY coordinates of the equirectangular image after the blur correction (reduction of the blur of the moving image).

In step S908, the control unit 101 performs processing (pixel generation processing) of generating pixels of the equirectangular image (equirectangular image after blur correction and mask superimposition) of the frame k. Details of the pixel generation processing will be described later with reference to FIG. 11.

In step S909, the control unit 101 updates the processing target coordinates (X, Y) to the next coordinates.

In step S910, the control unit 101 updates the variable k by adding 1 to the variable k.

FIG. 10 is a flowchart illustrating coordinate calculation processing performed in step S907 of FIG. 9.

In step S1001, the control unit 101 acquires the set processing target coordinates (X, Y).

In step S1002, the control unit 101 calculates, based on the coordinates (X, Y) acquired in step S1001, coordinates (x1, y1, z1) in the three-dimensional space corresponding to the coordinates (X, Y). The coordinates (x1, y1, z1) can be calculated based on a relationship in which the azimuth angle λ and the elevation angle ψ in the three-dimensional space are plotted in the X direction and the Y direction, respectively.

In step S1003, the control unit 101 corrects, based on the blur correction value acquired in step S903, the coordinates (x1, y1, z1) to coordinates (x2, y2, z2).

In step S1004, the control unit 101 calculates, based on the corrected coordinates (x2, y2, z2) acquired in step S1003, coordinates (x, y) of the circular fisheye image corresponding to the coordinates (X, Y) of the equirectangular image after blur correction.

FIG. 11 is a flowchart illustrating pixel generation processing performed in step S908 of FIG. 9.

In step S1101, the control unit 101 acquires the set processing target coordinates (X, Y) (coordinates (X, Y) of equirectangular image after blur correction).

In step S1102, the control unit 101 acquires the coordinates (x, y) of the circular fisheye image calculated in step S907.

In step S1103, the control unit 101 determines, based on the mask parameters acquired in step S904, whether the coordinates (X, Y) acquired in step S1101 are within a mask region. In a case in which the control unit 101 determines that the coordinates (X, Y) are within the mask region, the processing proceeds to step S1104. In a case in which the control unit 101 determines that the coordinates (X, Y) are outside the mask region (within the opening region), the processing proceeds to step S1105.

In step S1104, the control unit 101 sets a luminance coefficient to 0.

In step S1105, the control unit 101 sets the luminance coefficient to 1.

In step S1106, the control unit 101 multiplies the luminance value of the pixel at coordinates (x, y) acquired in step S1102 in the circular fisheye image of the frame k by the luminance coefficient set in step S1104 or step S1105. In a case in which the coordinates (X, Y) are within the mask region, a black pixel value (a pixel value of the mask) is obtained. As a result, the pixel value of the coordinates (X, Y) of the equirectangular image after blur correction and mask superimposition is obtained. Note that the color of the mask is not limited to black.

Note that, although an example in which the luminance coefficient is a binary value of 0 or 1 has been described, the luminance coefficient may be changed stepwise or continuously so that the luminance value changes smoothly at a boundary between the inside and the outside of the mask region. For example, the luminance coefficient may be determined according to a distance from coordinates corresponding to the lens center to the coordinates (X, Y), or the luminance coefficient may be determined according to a distance from the boundary between the inside and the outside of the mask region to the coordinates (X, Y).

A mask generation method according to the first embodiment will be described.

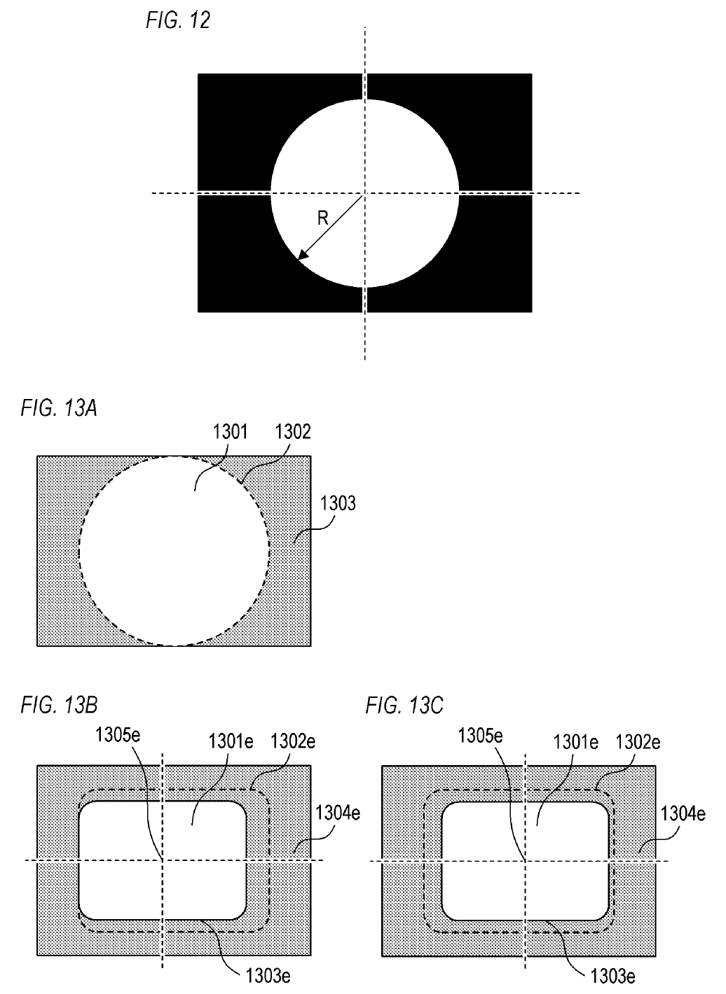

FIG. 12 is a schematic diagram illustrating a circular fisheye image. In FIG. 12, a mask having an opening region with a radius R (mask radius R) is superimposed on a circular fisheye image. A black region is a mask region, and a white region is an opening region. In order to obtain a wide effective region, it is preferable to generate a mask so as to expose the entire image circle. Ghosting and flare light are likely to appear in a region outside the image circle (invalid region). In order to hide ghosting and flare light, it is preferable to generate a mask so as to cover the entire invalid region. In consideration of these circumstances, it is preferable to generate the mask such that the opening region coincides with the region of the image circle. However, in a case in which such a mask is generated, as described above, when blur correction is performed, an unnecessary region corresponding to an invalid region is set as a part of the equirectangular image, and the unnecessary region moves according to a change in the blur correction value, so that flickering occurs in the peripheral portion of the equirectangular image.

A case in which a distance corresponding to the maximum value of an absolute value of the blur correction value among the distances from the center of the circular fisheye image is Δmax is considered. In this case, the unnecessary region can be hidden by setting a value smaller than an image circle radius imgR by the distance Δmax as the mask radius R. In FIG. 8, the absolute value of the blur correction value 805 is the maximum value. In FIG. 8, the blur correction value 805 is indicated by an angle, but the distance Δmax can be derived from a projection equation f×θ. However, when the value smaller than the image circle radius imgR by the distance Δmax is set as the mask radius R, the mask radius R becomes extremely small, and the effective region becomes extremely small.

Therefore, in the first embodiment, the opening region of the mask is moved by a mask movement amount, which is a moving average of the blur correction values, so that the opening region of the mask moves more gradually than the movement of the target region of the equirectangular transformation. Then, a value smaller than the image circle radius imgR by the maximum value Δθmax of a difference between the moving average and the blur correction value is set as the mask radius R (mask size). A value obtained by adding the mask movement amount and the mask size coincides with the maximum value of the blur correction amount. This makes it possible to hide the unnecessary region while suppressing the effective region from becoming excessively small.

In FIG. 8, the alternate long and short dash line 802 indicates the temporal change of the moving average of the blur correction values (mask movement amount), and the difference 808 between the moving average (mask movement amount) and the blur correction value is the mask size. A broken line 806a indicates a temporal change of a value obtained by shifting the mask movement amount in the - direction by the mask size, and a broken line 806b indicates a temporal change of a value obtained by shifting the mask movement amount in the + direction by the mask size. The broken lines 806a and 806b correspond to the case of using the mask according to the first embodiment. An alternate long and two short dashes line 807a indicates a value obtained by adding a minus sign to the absolute value (maximum value) of the blur correction value 805, and an alternate long and two short dashes line 807b indicates a value obtained by adding a plus sign to the absolute value (maximum value) of the blur correction value 805. The alternate long and two short dashes lines 807a and 807b correspond to a case (comparative example) in which both the opening region and the mask size are fixed. In the first embodiment, since the blur correction value is not below the broken line 806a and not above the broken line 806b, the unnecessary region can be completely hidden. In the comparative example as well, since the blur correction value is not below the alternate long and two short dashes line 807a and not above the alternate long and two short dashes line 807b, the unnecessary region can be completely hidden. As described above, in both the first embodiment and the comparative example, the unnecessary region can be completely hidden. However, in the comparative example, as the absolute value (maximum value) of the blur correction value 805 is greater, the mask size is smaller, and the absolute value (maximum value) of the blur correction value 805 is greater than the difference 808. Therefore, in the first embodiment, the opening region (effective region) can be made larger than that in the comparative example.

Each image and each region according to the first embodiment will be described.

FIG. 13A is a schematic diagram illustrating a circular fisheye image. A region 1301 is an image circle inner region (a region inside an image circle). A region 1303 is an image circle outer region (a region outside the image circle). A broken line 1302 is a boundary line between the image circle inner region 1301 and the image circle outer region 1303.

FIG. 13B is a schematic diagram illustrating an equirectangular image. A region 1301eis an effective region and is an opening region of a mask. A position 1305e is a center position of the opening region 1301e (effective region). A region 1304eis a region covered by the mask (a mask region). A solid line 1303eis a boundary line between the opening region 1301e (effective region) and the mask region 1304e. A broken line 1302e corresponds to the boundary line 1302 between the image circle inner region 1301 and the image circle outer region 1303. As described above, the boundary line 1302emoves according to the blur correction. The mask is superimposed such that the boundary line 1302e is not located inside the opening region 1301e (inside the boundary line 1303e between the opening region 1301e and the mask region 1304e). In this way, flickering and the like in the peripheral portion of the equirectangular image can be suppressed.

FIG. 13C is a schematic diagram illustrating an equirectangular image of a frame subsequent to the frame in FIG. 13B. The center position 1305e of the opening region 1301e gradually moves according to the mask movement amount. Accordingly, even when a relatively large opening region 1301e is set, the boundary line 1302e can be prevented from being positioned inside the opening region 1301e.

As described above, according to the first embodiment, the mask is generated such that the region not covered by the mask in the equirectangular image moves by the movement amount based on the temporal change of the blur correction amount. In this way, unnecessary regions such as black regions can be effectively reduced from the equirectangular image. An image having a small unnecessary region and a wide effective region can be obtained as the equirectangular image after the mask is superimposed.

Note that, although an example in which one circular fisheye image is transformed into one equirectangular image by equirectangular transformation has been described, the image before transformation is not limited to the circular fisheye image, and the image after transformation is not limited to the equirectangular image. The transformation is not limited to equirectangular transformation, and may be another geometric transformation. Furthermore, in a case in which a plurality of images respectively corresponding to a plurality of optical systems are acquired as images before transformation, geometric transformation, mask generation, and mask superimposition may be performed on each of the plurality of images.

### Second Embodiment

A second embodiment of the present disclosure will be described. Hereinafter, descriptions of the same points (configuration, processing, and the like) as those of the first embodiment will be appropriately omitted. In the first embodiment, the mask size is determined by the editing device 100. In the second embodiment, the mask size is specified by the user. Then, the mask movement amount is determined based on the mask size and the temporal change of the blur correction amount.

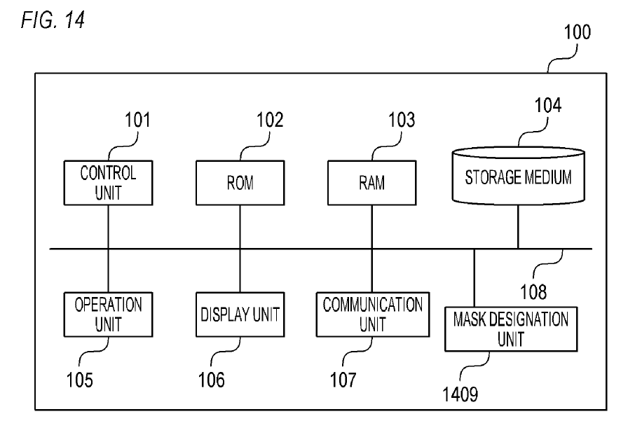

FIG. 14 is a block diagram illustrating a configuration of the editing device 100 which is an example of an image processing apparatus according to the second embodiment. The editing device 100 in FIG. 14 includes the control unit 101, the ROM 102, the RAM 103, the storage medium 104, the operation unit 105, the display unit 106, the communication unit 107, and the system bus 108, similarly to the editing device 100 in FIG. 1 (the editing device 100 according to the first embodiment). Furthermore, the editing device 100 in FIG. 14 includes a mask designation unit 1409. The mask designation unit 1409 receives a user operation (an instruction from the user) for designating the mask size.

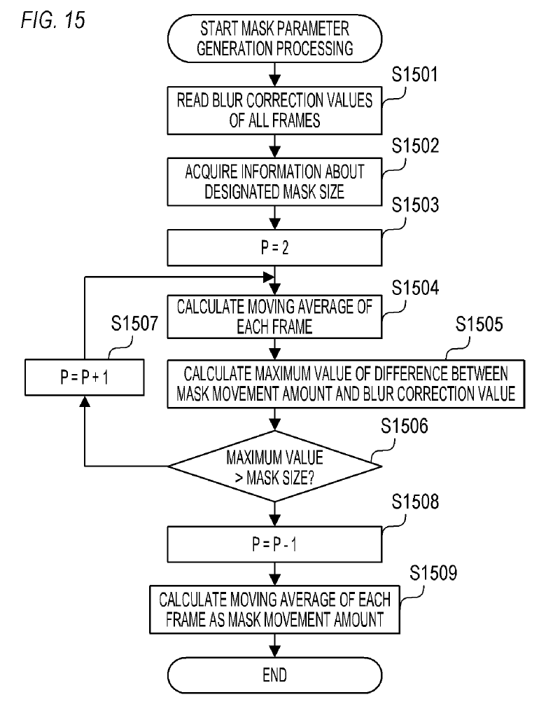

FIG. 15 is a flowchart illustrating mask parameter generation processing according to the second embodiment. The generation processing in FIG. 15 is performed in step S503 in FIG. 5.

In step S1501, the control unit 101 reads the blur correction values of all the frames calculated in step S502.

In step S1502, the control unit 101 acquires information about the mask size designated by the user from the mask designation unit 1409. The user designates a small mask size in a case in which the user wants to reduce the movement of the opening region of the mask, and designates a large mask size in a case in which the user wants to expand the opening region.

In step S1503, the control unit 101 sets a moving average period P, which is a period for averaging the blur correction values, to 2. The moving average period P = 2 means that the moving average period is a period of two frames including the frame for which the moving average of the blur correction values is calculated.

In step S1504, the control unit 101 calculates the moving average of the blur correction values of the respective frames using the blur correction values of all the frames read in step S1501 and the set moving average period P.

In step S1505, the control unit 101 calculates the maximum value of the difference (absolute value) between the blur correction value and the moving average as in the first embodiment.

In step S1506, the control unit 101 determines whether the maximum value calculated in step S1505 is greater than the mask size designated by the user. In a case in which the control unit 101 determines that the maximum value is greater than the mask size, the processing proceeds to step S1508. In a case in which the control unit 101 determines that the maximum value is less than or equal to the mask size, the processing proceeds to step S1507.

In step S1507, the control unit 101 updates the moving average period P by adding 1 to the moving average period P.

In step S1508, the control unit 101 updates the moving average period P by subtracting 1 from the moving average period P.

In step S1509, the control unit 101 calculates the moving average of the blur correction values of the respective frames as the mask movement amount of each frame using the blur correction values of all the frames read in step S1501 and the set moving average period P.

As described above, according to the second embodiment, in the configuration in which the user designates the mask size, the same effect can be obtained by the same operation as in the first embodiment. Furthermore, since the moving average period P is set such that the difference (absolute value) between the blur correction value and the moving average is maximized within a range not exceeding the mask size, the movement of the opening region of the mask can be minimized.

### Third Embodiment

A third embodiment of the present disclosure will be described. Hereinafter, descriptions of the same points (configuration, processing, and the like) as those of the first embodiment will be appropriately omitted.

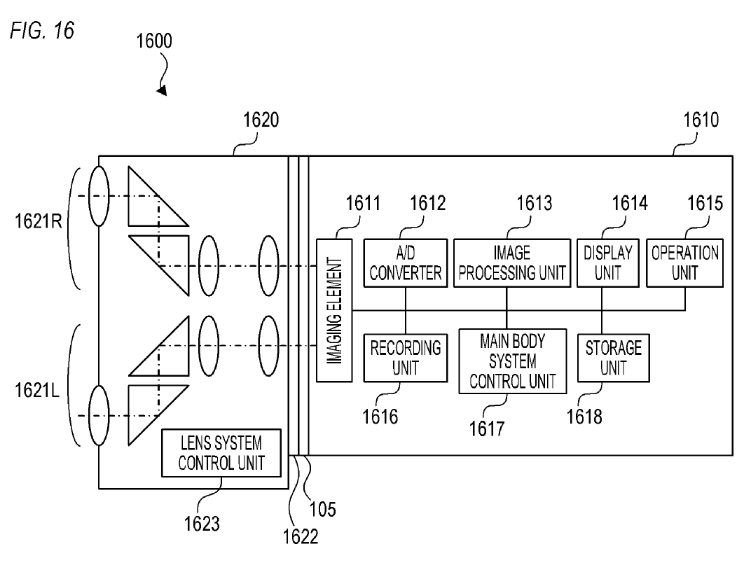

FIG. 16 is a block diagram illustrating a configuration of a shooting device 1600 which is an example of an image processing apparatus according to a third embodiment. The shooting device 1600 includes a camera main body 1610 and an interchangeable lens 1620.

The interchangeable lens 1620 is detachable from the camera main body 1610, and includes a right optical system 1621R, a left optical system 1621L, a lens mount 1622, and a lens system control unit 1623. The lens system control unit 1623 performs drive control of the right optical system 1621R and the left optical system 1621L, and the like. The right optical system 1621R and the left optical system 1621L are arranged to be spaced apart from each other in the horizontal direction with a predetermined distance (baseline length) therebetween. In an imaging element 1611 included in the camera main body 1610, two image circles corresponding to the right optical system 1621R and the left optical system 1621L are formed. When viewed from the imaging element 1611 side, the right optical system 1621R is disposed on the right side, and the left optical system 1621L is disposed on the left side. Therefore, a moving image or a still image shot through the right optical system 1621R can be recorded as an image for the right eye, and a moving image or a still image shot through the left optical system 1621L can be recorded as an image for the left eye. Using the 3D display or the VR goggles, an image for the right eye and an image for the left eye are played such that a video based on the image for the right eye is presented to the right eye of the user and a video based on the image for the left eye is presented to the left eye of the user. By doing so, the user can stereoscopically view the video.

The camera main body 1610 includes the imaging element 1611, an A/D converter 1612, an image processing unit 1613, a display unit 1614, an operation unit 1615, a recording unit 1616, a main body system control unit 1617, a storage unit 1618, and a camera mount 1619. When the lens mount 1622 of the interchangeable lens 1620 is mounted on the camera mount 1619 of the camera main body 1610, the main body system control unit 1617 and the lens system control unit 1623 are electrically connected.

The imaging element 1611 converts a formed image (optical signal) of the object into an analog electric signal. The A/D converter 1612 converts the analog electric signal output from the imaging element 1611 into a digital electric signal (an image signal). The image processing unit 1613 performs various types of image processing on the digital electric signal (image signal) output from the A/D converter 1612.

The display unit 1614 displays various types of information. The display unit 1614 is, for example, an electronic viewfinder, a back surface display unit, or the like, and includes a liquid crystal panel, an organic EL panel, or the like as a display panel. The operation unit 1615 is a user interface that receives a user's operation on the shooting device 1600. Note that, in a case in which the display unit 1614 includes a touch panel, the touch panel is also one of the operation units 1615.

The recording unit 1616 records various types of data such as image data subjected to image processing by the image processing unit 1613 in the storage unit 1618 or the like. The storage unit 1618 stores individual identification information such as individual information and manufacturing error information of the shooting device 1600. In general, the interchangeable lens 1620 has an error (manufacturing error) generated in the manufacturing process thereof. Due to this manufacturing error, for example, when the interchangeable lens 1620 is attached to the camera main body 1610, inclination or positional displacement of the right optical system 1621R with respect to the imaging element 1611 occurs. Similarly, inclination or positional displacement of the left optical system 1621L with respect to the imaging element 1611 occurs. In the third embodiment, the main body system control unit 1617 or the image processing unit 1613 acquires and uses the information about the manufacturing error to convert the circular fisheye image into an equirectangular image in which the impact of the manufacturing error is mitigated.

The main body system control unit 1617 is, for example, a CPU, and integrally controls the entire shooting device 1600.

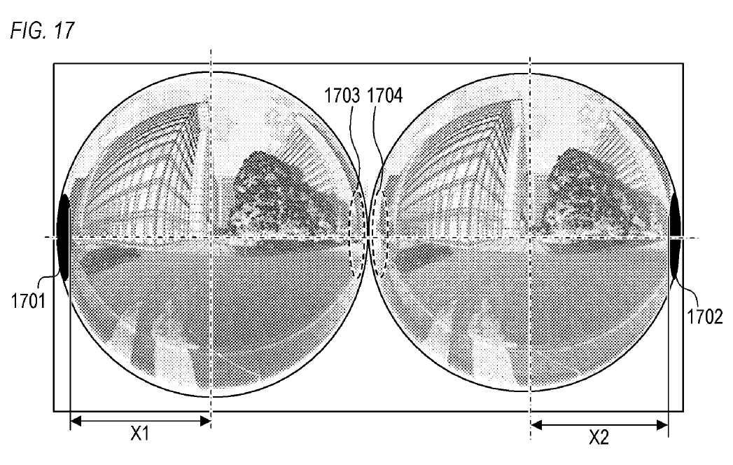

FIG. 17 is an image shot by the shooting device 1600. The image in FIG. 17 has two regions of the circular fisheye image shot via two optical systems including the right optical system 1621R and the left optical system 1621L. Here, it is assumed that the angle of view of each of the right optical system 1621R and the left optical system 1621L is a very wide angle of view of 180 degrees or more. Therefore, a shooting device (for example, the other optical system or the like) is captured in the circular fisheye image of one optical system. In FIG. 17, regions 1701 and 1702 are regions in which the adjacent optical system is captured. Here, the circular fisheye image corresponding to the right optical system 1621R is arranged on the left side, and the circular fisheye image corresponding to the left optical system 1621L is arranged on the right side. The reason for this is that an image in FIG. 17 is obtained by rotating, by 180 degrees, an image obtained by vertically and horizontally inverting the optical image through the right optical system 1621R to the right side and vertically and horizontally inverting the optical image through the left optical system 1621L to the left side. Therefore, the regions 1701 and 1702 are arranged outside.

Although the same object as that in a region 1704 should be captured in the region 1701, the adjacent optical system (the left optical system 1621L) is captured in the region 1701, so that different objects are captured in the region 1701 and the region 1704. Although the same object as that in a region 1703 should be captured in the region 1702, the adjacent optical system (the right optical system 1621R) is captured in the region 1702, so that different objects are captured in the region 1702 and the region 1703. As described above, when different objects appear in two regions where a similar object should appear, stereoscopic vision cannot be performed, or stereoscopic vision with a sense of discomfort is performed.

Therefore, in the third embodiment, a region in which the shooting device 1600 is captured is set as an unnecessary region, and a mask is generated so as to cover the unnecessary region. By covering not only the regions 1701 and 1702 but also the regions 1703 and 1704 with a mask, it is possible to further reduce a sense of discomfort in stereoscopic vision. In the third embodiment, equirectangular transformation, mask generation, and mask superimposition are performed on each of the right optical system 1621R and the left optical system 1621L. The mask can be generated in a manner similar to the first and second embodiments, and the equirectangular image on which the mask is superimposed is generated by the main body system control unit 1617 or the image processing unit 1613. However, for the right optical system 1621R, the mask movement amount and the mask size are set in further consideration of a distance X1 from the center of the image circle to the region 1701 (and the region 1703) so that the opening region of the mask does not include the region 1701 (and the region 1703). For example, a mask size smaller than that of the first embodiment by the distance X1 is set. Similarly, for the left optical system 1621L, the mask movement amount and the mask size are set in further consideration of a distance X2 from the center of the image circle to the region 1702 (and the region 1704) so that the opening region of the mask does not include the region 1702 (and the region 1704).

In addition, as described above, in the third embodiment, the circular fisheye image is transformed into the equirectangular image in which the impact of the manufacturing error is mitigated by using the information about the manufacturing error. Accordingly, the main body system control unit 1617 or the image processing unit 1613 generates, based on the information about the manufacturing error, a mask in which the impact of the manufacturing error is mitigated.

As described above, according to the third embodiment, it is possible to effectively reduce a region in which the shooting device is captured from the geometrically transformed image. Furthermore, by performing the geometric transformation and the mask generation in consideration of the manufacturing error, a suitable image in which the impact of the manufacturing error is mitigated can be obtained as the image after the geometric transformation and the mask superimposition.

[0 165 ] Note that the above-described various types of control may be processing that is carried out by one piece of hardware (e.g., processor or circuit), or otherwise. Processing may be shared among a plurality of pieces of hardware (e.g., a plurality of processors, a plurality of circuits, or a combination of one or more processors and one or more circuits), thereby carrying out the control of the entire device.

[0 166 ] Also, the above processor is a processor in the broad sense, and includes general-purpose processors and dedicated processors. Examples of general-purpose processors include a central processing unit (CPU), a micro processing unit (MPU), a digital signal processor (DSP), and so forth. Examples of dedicated processors include a graphics processing unit (GPU), an application-specific integrated circuit (ASIC), a programmable logic device (PLD), and so forth. Examples of PLDs include a field-programmable gate array (FPGA), a complex programmable logic device (CPLD), and so forth.

[0 167 ] The embodiment described above (including variation examples) is merely an example. Any configurations obtained by suitably modifying or changing some configurations of the embodiment within the scope of the subject matter of the present disclosure are also included in the present disclosure. The present disclosure also includes other configurations obtained by suitably combining various features of the embodiment.

According to the present disclosure, unnecessary regions such as black regions can be effectively reduced from a geometrically transformed image such as an equirectangular projection image.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)^{TM}), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-072939, filed April 25, 2025, which is hereby incorporated by reference herein in its entirety.

What is claimed is:

1. An image processing apparatus comprising:
a processor; and
a memory storing a program which, when executed by the processor, causes the image processing apparatus to execute
moving image acquisition processing of acquiring a shot moving image,
acquisition processing of acquiring a blur correction amount for reducing blur of the moving image,
image processing of performing geometric transformation on an image of each frame of the moving image, wherein in the image processing, an image in which the blur is reduced as a geometrically transformed image, based on the blur correction amount,
generation processing of, based on a temporal change in the blur correction amount, generating a mask, and
superimposition processing of superimposing the mask on the geometrically transformed image,
wherein in the generation processing, the mask is generated such that a region not covered by the mask in the geometrically transformed image has a size designated by a user and moves by a movement amount based on the size and the temporal change in the blur correction amount.

2. The image processing apparatus according to claim 1, wherein in the generation processing, the mask is generated such that the region not covered by the mask moves by a movement amount corresponding to a moving average of the blur correction amount in a period based on the size.

3. The image processing apparatus according to claim 2, wherein in the generation processing, a period during which a difference between the blur correction amount and the movement amount becomes maximized within a range not exceeding the size is determined as the period during which the moving average is obtainable.

4. The image processing apparatus according to claim 1, wherein is the generation processing, the mask is generated such that the size of the region not covered by the mask does not change.

5. The image processing apparatus according to claim 1, wherein
the image of each frame of the moving image has a region inside an image circle and a region outside the image circle, and
the mask covers the region outside the image circle.

6. The image processing apparatus according to claim 1, wherein
the image of each frame of the moving image is an image in which a shooting device that shoots the moving image is captured, and
the mask is a mask that covers a region in which the shooting device is captured.

7. The image processing apparatus according to claim 1, wherein
when the program is executed by the processor, the program further causes the image processing apparatus to execute information acquisition processing of acquiring information on a manufacturing error of an optical system that shoots the moving image, wherein
in the image processing, an image in which an impact of the manufacturing error is mitigated is acquired as the geometrically transformed image, based on the information on the manufacturing error, and
in the generation processing, the mask in which the impact of the manufacturing error is mitigated is generated based on the information on the manufacturing error.

8. The image processing apparatus according to claim 1, wherein
the image of each frame of the moving image includes a plurality of images respectively corresponding to a plurality of optical systems,
in the image processing, the geometric transformation is performed on each of the plurality of images, and
in the generation processing, the mask is generated for each of the plurality of images.

9. The image processing apparatus according to claim 1, wherein
the image of each frame of the moving image includes a circular fisheye image having a region inside an image circle and a region outside the image circle, and
in the image processing, equirectangular transformation, which is the geometric transformation, is performed on the circular fisheye image.

10. An image processing method comprising:
acquiring a shot moving image;
acquiring a blur correction amount for reducing blur of the moving image;
performing geometric transformation on an image of each frame of the moving image, wherein an image in which the blur is reduced is acquired as a geometrically transformed image, based on the blur correction amount;
generating a mask based on a temporal change in the blur correction amount; and
superimposing the mask on the geometrically transformed image,
wherein the mask is generated such that a region not covered by the mask in the geometrically transformed image has a size designated by a user and moves by a movement amount based on the size and the temporal change in the blur correction amount.

11. A non-transitory computer readable medium that stores a program, wherein the program causes a computer to execute an image processing method comprising:
acquiring a shot moving image;
acquiring a blur correction amount for reducing blur of the moving image;
performing geometric transformation on an image of each frame of the moving image, wherein an image in which the blur is reduced is acquired as a geometrically transformed image, based on the blur correction amount;
generating a mask based on a temporal change in the blur correction amount; and
superimposing the mask on the geometrically transformed image,
wherein the mask is generated such that a region not covered by the mask in the geometrically transformed image has a size designated by a user and moves by a movement amount based on the size and the temporal change in the blur correction amount.
